(19) United States
(12) Patent Application Publication
(10) Pub. No.: US 2006/0176787 A1
(43) Pub. Date: Aug. 10, 2006

(54) Method of storing information on an optical disc

(75) Inventor: Martinus Wilhelmus Blum, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N. V., Eindhoven (NL)

(21) Appl. No.: 10/549,346

(22) PCT Filed: Mar. 17, 2004
(86) PCT No.: PCT/IB04/50271

§ 371 Date: Sep. 14, 2005

(30) Foreign Application Priority Data
Mar. 19, 2003 (EP) 03100703.2

(51) Int. Cl. G11B 5/09

(52) U.S. Cl. 369/47.1; 369/53.2; 369/59.1

(57) ABSTRACT

The present invention relates in general to a method of storing information on an optical disc. More specifically, the present invention relates to a storage method according to a standard where ECC blocks are written between run-in/run-out fields.

### FIELD OF THE INVENTION

The present invention relates in general to a method of storing information on an optical disc. More specifically, the present invention relates to a storage method according to a standard where ECC blocks are written between run-in/run-out fields.

Furthermore, the present invention relates to a disc drive apparatus for writing/reading information into/from an optical storage disc; hereinafter, such a disc drive apparatus will also be indicated as “optical disc drive”.

### BACKGROUND OF THE INVENTION

As is commonly known, an optical storage disc comprises at least one track, either in the form of a continuous spiral or in the form of multiple concentric circles, of storage space where information may be stored in the form of a data pattern. Optical discs may be of the read-only type, where information is recorded during manufacture, which information can only be read by a user. The optical storage disc may also be of a writable type, where information may be stored by a user. Such disc can be of a write-once type, which can only be written once, or of a rewritable type, which can be written many times. Specifically, the present invention relates to the field of rewritable discs, although the scope of the invention is not limited to this field since the features of the invention are also applicable to other types of disc. Since the technology of optical discs in general, the way in which information can be stored in an optical disc, and the way in which optical data can be read from an optical disc, is commonly known, it is not necessary here to describe this technology in more detail.

When storing information on a record medium, the information is coded in data words in accordance with a predetermined format. For different applications, different formats exist. One general problem is that, on writing and/or on reading, errors may happen, so that the data read back from a recording is not identical to the original data. This is undesirable. Therefore, error-correction schemes have been developed, capable of correcting data errors to a certain extent. Such error-correction schemes involve the addition of error correction bits to the original data In a particular class of error-correction schemes, a predefined amount of original data and error-correction bits are mixed together, according to a predefined algorithm. The combination forms an Error Correction Code block (ECC block). An ECC block contains a predetermined amount of data. If the amount of data to be stored is larger than the data capacity of one ECC block, the data is written in a plurality of ECC blocks.

It is noted that each ECC block is to be regarded as a unit of coded information, i.e. for reading information back it is not sufficient to read just a portion of an ECC block: the block needs to be read and treated as a whole, because the decoding algorithm needs to have all data from the block. Thus, it is only possible to decode the block as a whole.

Since coding schemes for ECC blocks are known to those skilled in the art, while furthermore the present invention is not related to the coding scheme as such, a detailed discussion of a coding algorithm will be omitted here. By way of example, reference is made to the DVD standard ECMA 267: “120 mm DVD-Read Only Disc”, December 1997, Section 4 “Data Format”.

In some formats, it is expected that blocks are written in a substantially continuous stream behind each other; DVD is an example of such a format. Other formats exist, which allow a user to write any block at any desired address on disc; Blu-Ray Disc is an example of such a format. The present invention relates specifically to the latter type of format, which will hereinafter be indicated as “Random Access” (RA) format. When writing or reading such a block, a disc drive needs to know where to start and stop, and needs to become “synchronized” with the physical track. In the case of reading, this is done by starting to read in the block immediately preceding the target block. In the case of writing, previously stored information can also be read when approaching the target location; even so, it is very difficult to start writing immediately from the end of the previous block.

In order to overcome this problem, and more particularly in order to provide a sufficient margin for linking two subsequent blocks, an RA format requires that a so-called run-in field be placed before a block to be recorded, and that a so-called run-out field be placed after such a block. Thus, two consecutively recorded blocks are separated by a sequence of a run-out field and a run-in field, which provides a margin necessary for error-free linking. Hereinafter, these fields will be indicated as RIF and ROF, respectively.

There is a trend towards reducing physical dimensions of data storage equipment. Recently a disc drive for small discs (SFFO) was developed suitable for implementation in mobile equipment such as a mobile telephone, Personal Digital Assistant (PDA), etc. In such mobile applications the disc drive will be powered from a battery, so it is desirable to increase the lifetime of the power source as much as possible.

During a writing operation or a reading operation, the power consumption of the disc drive is relatively large as compared with the power consumption at other times. On the other hand, the data rate (writing speed; reading speed) of the disc drive is much greater than the data rate of the application processing the data, i.e. a user application providing the data to be written or receiving the data as read. Typically, the disc drive is capable of operating at a speed of 36 Mb/s whereas an application typically can handle only 1 Mb/s. Therefore, it is proposed to provide the disc drive with a energy buffer device such as a buffer capacitor, and to operate the disc drive in a “burst writing mode”. In respect of the writing process, such a mode comprises a data collection period and a data writing period. During the data collection period, data from the application is stored in a data buffer memory at the relatively low data rate as determined by the application; simultaneously, the power capacitor is charged from the battery. During the data writing period, during which the disc drive is powered from the power capacitor, data from the buffer memory is written to disc at the relatively high data rate as determined by the disc drive. Since, on average, the amount of data collected is equal to the amount of data written, the data collection period has a much longer duration than the data writing period. In the above example, the ratio of data collection period duration to data writing period duration is typically of the order of 36.

Since in this burst writing mode the charging of the capacitor takes place during a relatively long time as compared with the duration of a write burst, the charging current of the capacitor is much lower than the discharge current of the capacitor when powering the disc drive. In the above example, the charging current can be a factor 36 lower than the discharge current. Thus, a battery is now only required to continuously provide the smaller charging current for the capacitor instead of providing high peak currents during short bursts. As a result, the lifetime of a battery is substantially increased.

A problem in this respect is the physical size of the power capacitor. This size is determined by, inter alia, the required capacitance of the capacitor, which depends on the required peak current during a writing operation and on the duration of the writing operation. The required peak current is a characteristic of the disc drive. The duration of the writing operation is determined by the writing speed (Mb/s) and the length of the data fragment to be written (Mb).

In a realistic example, an ECC block has a size of 32 kbytes, so that, at a data rate of 36 MBit/sec, writing or reading of such block would take about 7.3 ms. Assuming that the disc drive requires about 1 W of power during a write or read operation at full speed, and assuming that the capacitor voltage is about 3 V on average, the average discharge current of the capacitor will be about 333 mA. Assuming that a voltage drop of about 2 V across the capacitor is allowed, the capacitor requires a capacitance of 333[mA]·7.3[ms]/2[V]≈1.2 mF. An exemplary practical 0.7 mF capacitor has dimensions 7·2·6 mm³.

The present invention aims to reduce the required size of the power capacitor.

### SUMMARY OF THE INVENTION

According to an important aspect of the present invention, an ECC block is subdivided into a plurality of block sections, each block section being provided with a leading field before and a trailing field after the block section. In respect of the subsequent block sections, the leading field and the trailing field perform the same functions as the RIF and the ROF, respectively, in respect of the consecutive ECC blocks.

According to a further important aspect of the present invention, the process of writing an ECC block comprises a sequence of writing operations for subsequently writing the individual block sections and their corresponding pairs of leading and trailing fields, separated by non-writing periods during which the power capacitor is recharged, instead of writing the ECC block in one go. Thus, instead of being written in one continuous writing session, an ECC block is now written in a series of smaller sessions, which will be indicated as micro-sessions. Since the duration of the micro-sessions is much smaller than the duration required for writing the entire ECC block, the power capacitor needs only to be capable of providing a substantially reduced amount of power, namely sufficient for the duration of the micro-sessions only, hence its size can be reduced.

### BRIEF DESCRIPTION OF THE DRAWINGS

These and other aspects, features and advantages of the present invention will be further explained by the following description of a preferred embodiment of the method according to the present invention with reference to the drawings, in which same reference numerals indicate same or similar parts, and in which:

FIGS. 1-2 are diagrams illustrating the storage space of a disc, specifically illustrating block length in relation to storage zone length;

FIG. 3 is a block diagram schematically illustrating relevant components of a disc drive apparatus;

FIG. 4 is a timing diagram schematically illustrating the operation of a disc drive apparatus;

FIG. 5 is a timing diagram comparable to FIG. 4, schematically illustrating the preferred operation of a disc drive apparatus according to the present invention;

FIG. 6 is a diagram schematically illustrating that a single ECC block is subdivided into multiple block segments with separating fields in between.

### DESCRIPTION OF THE INVENTION

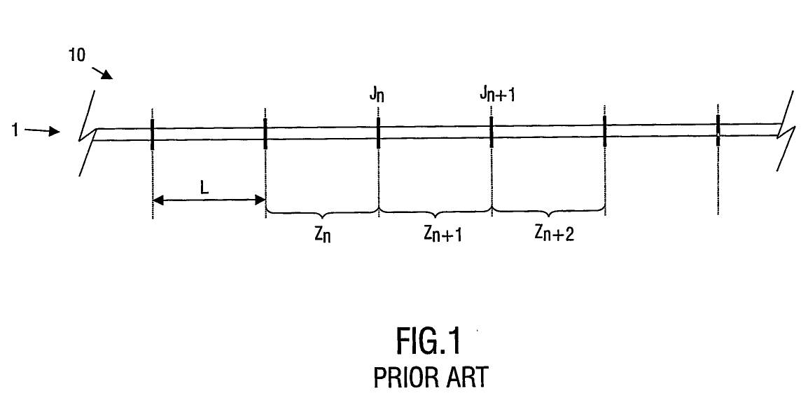

An optical storage disc 1 comprises at least one track, either in the form of a continuous spiral or in the form of multiple concentric circles, of storage space 10 where information may be stored in the form of a data pattern. This storage space 10 is physically present on the disc, arranged in the manufacturing process of the disc. Immediately after manufacture the storage space 10 is still empty, i.e. it contains no written data. FIG. 1 schematically shows part of the storage space 10, visualized as a continuous ribbon, for a case where the disc 1 is such a blank disc.

In a blank disc for use with a random access format, not only the tracks are present, but the tracks also already have a structure corresponding to locations where blocks of data are to be stored. In an example, the disc may comprise a wobble channel (not shown in FIG. 1) physically arranging the tracks as a series of consecutive storage zones Z. Other methods for defining storage zones are possible also. In the following, storage zones in general will be indicated as Z, while individual storage zones will be distinguished by the addition of index n, n+1, n+2, etc. Likewise, a junction between two adjacent zones will generally will be indicated as J, while individual junctions will be distinguished by the addition of index n, n+1, n+2, etc.

Since the predetermined arrangement of a track into a plurality of storage zones Z during manufacture and the use of the wobble channel as an example of defining storage zones are known to those skilled in this art, while furthermore such a division as such is not the subject of the present invention, further details in this respect are omitted here.

The disc 1 is intended for use with a predetermined format which describes, inter alia, the structure of the blocks to be written. More particularly, such a format describes the number of bytes of data and the number of error correction bits in each block, i.e. the number of bits in each block, which in turn, in conjunction with the required space for writing one bit, determines the physical length L of the zones Z. Typically, the Blu-Ray Disc format provides a block length of 64 kbytes of user data. It is noted that the data bytes and the correction bits belong together and form an inseparable Error Correction Code block or ECC block. On retrieval of the data, a decoder needs to have all data bits and all error correction bits of an ECC block in order to be able to decode any single data byte. Hereinafter, the size of an ECC block will be indicated in terms of data; thus, in view of the presence of the error correction bits, an ECC block is actually larger than the size mentioned (64 kbytes).

Examples of present-day formats are DVD-RW, DVD-ROM, CD-RW, CD-ROM, Blu-Ray-RE, Blu-Ray-ROM, etc. Blu-Ray Disc is a rather recent format which allows individual ECC blocks to be written in any desired storage zone Z of the disc (provided, of course, that the zone is not damaged or occupied). In order to enable the writing means of a disc drive apparatus to correctly write the entire contents of an ECC block, and in order to enable the reading means of a disc drive apparatus to correctly read the entire contents of an ECC block, the Blu-Ray Disc format prescribes the use of a run-in field (RIF) before and a run-out field (ROF) after each ECC block. Therefore, the physical length L of the zones Z corresponds to the overall length of one ECC block plus one RIF plus one ROF.

Since the notion of RIF/ROF is known to those skilled in this art, while the design and contents of such RIF/ROF is also known to those skilled in this art, a more detailed discussion thereof is omitted here.

FIG. 2 is a drawing similar to FIG. 1, schematically illustrating part of the storage space 10 having three ECC blocks ECC1, ECC2, ECC3 written in adjacent storage zones Z1, Z2, Z3, respectively. Each ECC block ECCi is flanked by a RIFi/ROFi pair, respectively, i being 1, 2, 3. It can be clearly seen in FIG. 2 that the combination of RIF1, ECC1, ROF1 fits precisely in the first zone Z1. Further, it can be recognized in FIG. 2 that the combination of ROF1 and RIF2 provides a margin between ECC1 and ECC2 at the junction J1 between Z1 and Z2.

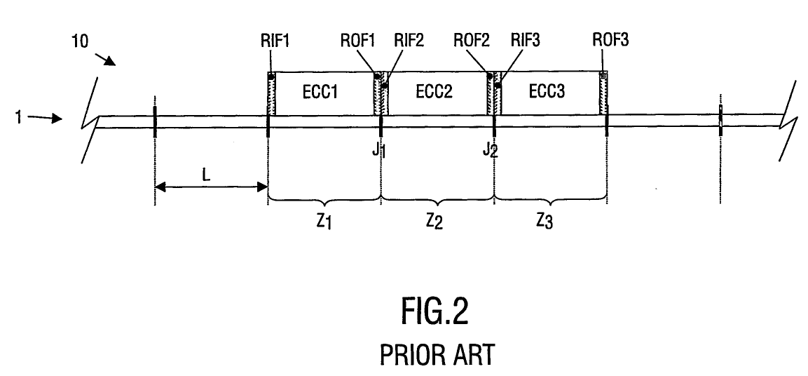

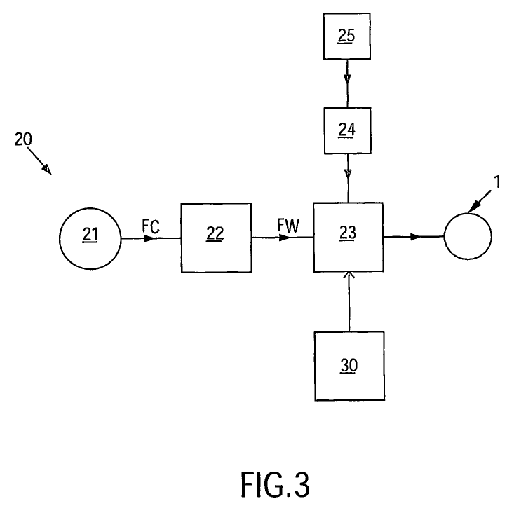

FIG. 3 is a block diagram schematically illustrating relevant components of a disc drive apparatus 20, designed for writing data to such a disc 1 in conformity with the above-mentioned ECC format. FIG. 4 is a timing diagram schematically illustrating the operation of the disc drive apparatus 20 as a function of time (horizontal axis).

An application (computer program) 21 provides data to be written to an encoder 22, which includes a data buffer, typically in a relatively low-rate data collection flow F_{C}. It is noted that the encoder 22 may be a standard encoder. It is further noted that the data rate R_{C} of the data collection flow F_{C} is determined by the application, depending on circumstances; for instance, in the case of video, the data rate depends on the image size. The actual data rate R_{C} is not important here and is visualized by the wavy shape of curve 41, which indicates the low-rate data flow F_{C} as a function of time. In a typical example, this data rate R_{C} is of the order of 1 Mb/sec.

The disc drive apparatus 20 further comprises writing means 23 for actually writing data to disc 1. Such writing means 23 typically comprise a laser for generating a laser beam and an optical system for focusing and directing the laser beam. Since such writing means 23 are commonly known and as such are no subject of the present invention, while furthermore the present invention can be implemented while incorporating known writing means, the details of such writing means are not shown in FIG. 3 for the sake of simplicity and will not be explained in more detail.

The data flow from encoder 22 to writing means 23 is indicated as data writing flow F_{W}.

The writing means 23 are not active at all times. Thus, the data writing flow F_{W} does not flow at all times. Controlled by a controller 30, the writing means 23 are inactive during a data collection period T_{DC}, during which data are collected in the encoder 22. During this data collection period T_{DC}, the data writing flow F_{W} is zero. Then, during a data writing period T_{W}, the writing means 23 are active in writing the data from encoder 22 to disc 1, at a data rate R_{W} which is now much higher than the data collection rate R_{C} of said relatively low-rate data flow F_{LR}. Typically, the relatively high-rate data flow F_{W} may have a data write rate R_{W} of 36 Mb/s. It should be clear that the ratio of the duration of data collection period T_{DC} to the duration of data writing period T_{W} is equal to the ratio of the data write rate R_{W} to the data collection rate R_{C}.

Controllers for controlling read/write means in the way described above are known. Therefore, a more detailed description of the general design and functioning of the controller 30 is omitted here.

In FIG. 4, it is illustrated that the data collection flow F_{C} continues during the writing period T_{W}; alternatively, it is possible that the data collection is interrupted during the writing period T_{W}.

The disc drive apparatus 20 comprises a battery 25 for power supply and a power capacitor 24 for buffering the power supply towards writing means 23. The third curve 43 in FIG. 4 illustrates the current through this power capacitor 24. During the writing period T_{W}, the writing means 23 consume power from the power capacitor 24, indicated as a drive current I_{D} being delivered by the power capacitor 24. During the data collection period T_{DC}, the power capacitor 24 is charged from the battery 25, indicated as a charge current I_{C} being consumed by the power capacitor 24. In can be clearly seen that the magnitude of the charge current I_{C} provided by the battery 25 is much smaller than the magnitude of the drive current I_{D} provided by the power capacitor 24, the ratio of I_{C}/I_{D} substantially corresponding to the ratio of T_{W}/T_{DC} and R_{C}/R_{W}. Due to this reduction of peak current consumption, the lifetime of the battery 25 is increased.

In the state of the art, ECC blocks are always written in one continuous writing session. Should this approach be continued, the duration of the writing period T_{W} indicated in FIG. 4 would necessarily correspond to the time needed for writing an integer number of ECC blocks ECC together with their corresponding RIFs and ROFs. The power capacitor 24 then has to be capable of storing the amount of power needed to do this, corresponding to the hatched area of curve 43, namely drive current I_{D} times writing period duration T_{W}, which translates into a certain physical size of the power capacitor 24. In this respect, a minimum writing period duration T_{W} would be defined by the size of one ECC block and its corresponding RIF and ROF.

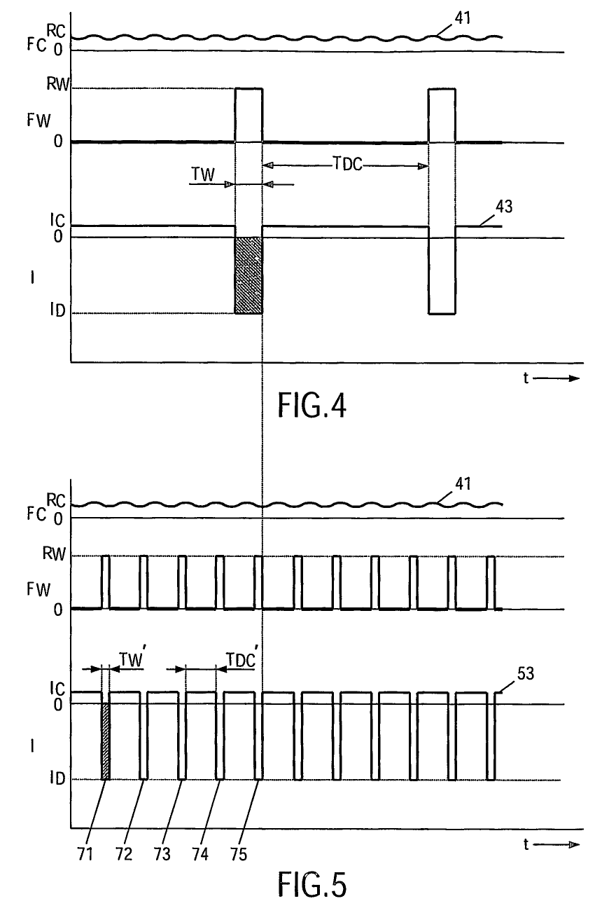

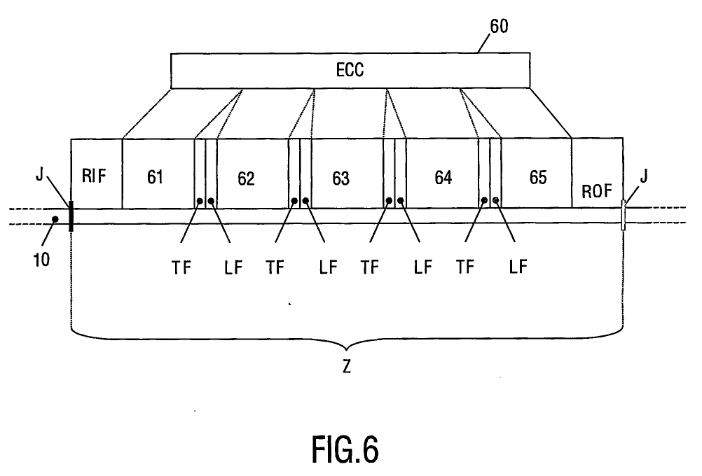

FIG. 5 is a timing diagram comparable to FIG. 4, now illustrating the preferred operation of the disc drive apparatus 20 as a function of time in accordance with the present invention. FIG. 6 is a diagram, comparable to FIG. 2, illustrating the structure of a recorded ECC block in accordance with the present invention.

According to the present invention, an ECC block 60 is subdivided into a plurality of N block sections 61, 62, 63, 64, 65. In this example, N equals 5; however, N may also be 2, 3, 4, or 6 or more. It is noted that the block sections do not individually constitute ECC blocks; only the collection of all N block sections 61, 62, 63, 64, 65 constitutes one ECC block.

Furthermore, according to the present invention, the ECC block 60 is not written in one continuous writing session but is written in a series of micro-sessions of shorter duration. During each micro-session d, one of the block sections 61-65 is written. Thus, the entire ECC block 60 is written in N subsequent micro-sessions denoted 71-75 in FIG. 5. Each individual micro-session 71-75 has a duration T_{W}′ substantially corresponding to the original duration T_{W} of one entire ECC block divided by N, i.e. T_{W}′≈T_{W}/N. Consequently, the power capacitor 24, which is recharged between successive micro-sessions, only needs to be capable of storing an amount of power needed to drive the writing means 23 during the reduced period T_{W}′, corresponding to the hatched area of curve 53. This reduced capacity requirement translates into a reduced physical size requirement of the power capacitor 24.

It is noted that each block section 61, 62, 63, 64, 65 is preceded by a leading field LF and followed by a trailing field TF, as indicated in the enlargement of FIG. 6, in order to provide a margin for linking two subsequent block sections without introducing bit errors. The first block section 61 does not need an additional leading field LF in view of the presence of the run-in field RIF. Likewise, the final block section 65 does not need an additional trailing field TF in view of the presence of the run-out field ROF.

It is noted that, in an exemplary embodiment, TF and LF may be identical to RIF and ROF, respectively. However, since the requirements for TF and LF are less than the requirements for RIF and ROF, TF and LF may be smaller than RIF and ROF, respectively, as illustrated. For instance, a RIF is designed with a view to the possibility that the corresponding ECC block is written without neighboring blocks, i.e. with an empty preceding block, whereas the block sections 61-65 always have that order on disc, so that each individual block section always has a non-empty predecessor.

It is noted that, in the above, the invention has been explained in the context of a disc drive apparatus which is powered from a battery. However, the present invention is not restricted to such an apparatus: a disc drive apparatus powered from a mains power supply may also write micro-blocks in micro-sessions.

Thus, the present invention succeeds in providing an improved method of storing information on an optical disc 1 which comprises at least one track 10 having predefined storage zones Z each having a predefined storage capacity. Data is coded to form an ECC block 60. The ECC block is subdivided into a plurality of block sections 61, 62, 63, 64, 65. In a plurality of consecutive micro-sessions, the respective block sections are written to disc. A block section is preceded by a leading field LF and followed by a trailing field TF. The first block section 61 of the ECC block is preceded by a run-in field RIF and the final block section 65 of the ECC block is followed by a run-out field ROF.

A disc drive apparatus 20 according to the present invention comprises writing means 23 which may be powered from a power capacitor during each writing micro-session, the power capacitor being charged from a battery during the intervals between successive micro-sessions. It is an advantage of the method proposed by the invention that the capacity of the power capacitor can be reduced, hence its physical size can be reduced.

It should be clear to those skilled in the art that the present invention is not limited to the exemplary embodiments discussed above, but that various variations and modifications are possible within the protective scope of the invention as defined in the appended claims. For instance, it is possible that, in one micro-session, more than one block section is written, so that the number of writing sessions is smaller than the number of block sections.

In the above, the block sections 61-65 are described as having equal length. Although this is preferred, it is not essential.

1. Method of writing an ECC block (60) to a storage medium (1), the method comprising the steps of:
dividing the ECC block into a plurality of N block sections (61, 62, 63, 64, 65);
and successively writing the block sections (61, 62, 63, 64, 65) to the storage medium;
wherein always two successive block sections are separated by a combination of a trailing field (TF) following a first one of said two successive block sections and a leading field (LF) preceding a second one of said two successive block sections.

2. Method according to claim 1, wherein the storage medium (1) is an optical disc.

3. Method according to claim 1, wherein the first block section (61) is preceded by a run-in field (RIF) and wherein the final block section (65) is followed by a run-out field (ROF).

4. Method according to claim 3, wherein the storage medium (1) has at least one track (10) having predefined storage zones (Z) each having a predefined storage capacity;
wherein the combination of the plurality of N block sections, N-1 sets of trailing field (TF) and leading field (LF), one run-in field (RIF), and one run-out field (ROF) is stored within one of said zones (Z).

5. Method according to claim 1, wherein the block sections are written during a plurality of successive micro-sessions (71, 72, 73, 74, 75) mutually separated by a time interval (T_{DC}′).

6. Method according to claim 5, wherein only one block section is written in a micro-session, together with the corresponding trailing field and the corresponding leading field.

7. Method according to claim 5, wherein a plurality of block sections are written in a session, together with the corresponding trailing fields and the corresponding leading fields.

8. Method according to claim 7, wherein said plurality is smaller than N, or is equal to N, or is greater than N.

9. Method according to claim 5, wherein the block sections are written by writing means (23) which are powered from a power capacitor (24); and
wherein the power capacitor (24) is charged during said time intervals (T_{DC}′) and discharged during said micro-sessions.

10. Method according to claim 9, wherein the power capacitor (24) is charged from a battery (25).

11. Method of storing information to a storage medium (1), the method comprising the steps of:
coding a first predetermined amount of data into an ECC block (60) according to a predefined format;
generating at least one leading field (LF) and at least one trailing field (TF);
writing the ECC block by a method according to claim 1.

12. Storage medium (1) containing at least one ECC block (60) of coded data stored therein, said at least one ECC block comprising a plurality of N successive block sections (61, 62, 63, 64, 65);
wherein two adjacent block sections are separated each time by a combination of a trailing field (TF) behind a first one of said two adjacent block sections and a leading field (LF) before a second one of said two adjacent block sections.

13. Storage medium according to claim 12, the storage medium being an optical disc.

14. Storage medium according to claim 13, further containing a run-in field (RIF) before the first block section (61) of said at least one ECC block and a run-out field (ROF) behind the last block section (65) of said at least one ECC block.

15. Storage medium according to claim 14, comprising at least one track (10) having predefined storage zones (Z) each having a predefined storage capacity;
wherein a sequence consisting of said run-in field (RIF), said plurality of N block sections and N-1 sets of trailing field (TF) and leading field (LF), and said run-out field (ROF) is contained in one of said zones.

16. Method of reading information from a storage medium according to claim 12, comprising the steps of:
a] recognizing a run-in field (RIF) as signaling the beginning of an ECC block (60);
b] reading a block section (61) until a trailing field (TF) is reached as signaling the end of the block section;
c] recognizing a leading field (LF) as signaling the beginning of a subsequent block section (62);
d] repeating steps [b]-[c] until in step [b] a run-out field (ROF) is reached as signaling the end of the ECC block;
e] combining the data of the respective block sections (61-65) read between said RIF and said ROF so as to reconstruct an ECC block (60);
f] decoding the reconstructed ECC block;
g] outputting the decoded data.

17. Disc drive apparatus (20) for storing information on an optical disc (1);
the disc drive apparatus being designed to perform the method according to claim 1.

18. Disc drive apparatus according to claim 17, comprising:
an encoder (22);
writing means (23) for writing data from the encoder (22) to an optical disc (1);
a controller (30) capable of controlling the writing means (23);
wherein the controller is designed to control the writing means to be active in writing data to disc during micro-sessions (71, 72, 73, 74, 75) and to be inactive during time intervals (T_{DC}′) between successive micro-sessions.

19. Disc drive apparatus according to claim 18, further comprising:
a power capacitor (24) for feeding the writing means (23) during said micro-sessions;
and a power supply (25), preferably a battery, for charging the power capacitor (24) during said time intervals (T_{DC}′) between successive micro-sessions.

20. Disc drive apparatus for reading information from a storage medium (1) containing at least one ECC block (60) of coded data stored therein, said at least one ECC block comprising a plurality of N successive block sections (61, 62, 63, 64, 65);
wherein two adjacent block sections are separated each time by a combination of a trailing field (TF) behind a first one of said two adjacent block sections and a leading field (LF) before a second one of said two adjacent block sections;
the disc drive apparatus being designed to perform the method according to claim 16.
